(19) United States
(12) Patent Application Publication
(10) Pub. No.: US 2002/0196726 A1
(43) Pub. Date: Dec. 26, 2002

(54) Optical pickup device

(76) Inventor: Tadashi Takeda, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 10/177,662

(22) Filed: Jun. 18, 2002

(30) Foreign Application Priority Data
Jun. 21, 2001 (JP) 2001-187426

(51) Int. Cl. G11B 7/00

(52) U.S. Cl. 369/112.04

(57) ABSTRACT

An optical pickup device is equipped with a first light source that emits a first laser beam, a second light source that emits a second laser beam having a wavelength shorter than a wavelength of the first laser beam, and a common light path that conducts the first laser beam and the second laser beam emitted from the respective light sources to an optical recording medium. The optical pick up device includes a first diffraction grating and a second diffraction grating disposed on the common light path arranged in this order from the first and second light sources. The first diffraction grating diffracts the first laser beam and generates three beams for detecting tracking error, and transmits the second laser beam without diffracting the second laser beam, and the second diffraction grating diffracts the second laser beam and generates three beams for detecting tracking error, and transmits the first laser beam without diffracting the first laser beam.

### BACKGROUND OF THE INVENTION

1. Field of the Invention

The present invention relates to optical pick up devices used in the reproduction of data recorded on optical recording media such as compact disks (CD) and digital versatile disks (DVD), and more particularly to optical pickup devices equipped with diffraction grating for detecting tracking errors with a three-beam method.

2. Description of Related Art

As an optical pickup device, a two-wavelength optical pickup device is known. The two-wavelength optical pickup device is equipped with a 650 nm band laser diode used for reproducing data on DVDs and a 780 nm band laser diode for reproducing and recording data on CD-Rs.

The two-wavelength optical pickup device shares the usage of optical elements by using a common optical system for the respective laser beams in order to make the system smaller and compact.

For example, a beam splitter that separates light beams emitted from the laser diode and the laser beams that return from an optical recording medium is positioned on a common light path. A first half reflector surface formed on the surface of the beam splitter separates the first laser beam for reproducing information for the DVD player and a second half reflector surface formed on the rear side of the beam splitter separates the second laser beam for reproducing data for the CD-R.

The two-wavelength optical pickup device described above uses a single beam and one spot method for detecting tracking error. However, in order to accommodate different recording type media such as CD-RW, DVD-R, DVD-RW and DVD-RAM, it is desirable to use a three-spot method that uses three beams formed by passing a laser beam through a diffraction grating in order to enhance detection stability.

In this case, an addition of two diffraction gratings may be considered to diffract each of the laser beams with different wavelengths into three respective beams. However, in the two-wavelength optical pickup device in which two laser diodes are incorporated into a single package, the two laser beams are led to an optical recording medium via a common light path because the positions of the light emitting points of the two laser diodes are extremely close to one another.

As a result, the following problems occur as the two laser beams pass inevitably through two diffraction gratings.

First, unnecessary diffraction beams are generated because the laser beams of respective wavelengths are respectively subjected to two diffraction actions. Because of this, the light intensity of the three beams required for detecting tracking error declines and lowers the strength of the three light spots formed by the three beams from the respective lasers on the photo detector device, making it difficult to perform the detection with precision.

Also, it is necessary to rotate the diffraction gratings around the light axis to adjust the diffraction direction so that the three beams form light spots on the appropriate positions on the optical recording medium. However, the track pitches of CD and DVD differ, and the two laser beams are diffracted by the two diffraction gratings.

Because of this, even though the rotation of the respective diffraction gratings is adjusted around the light axis so that the light spots are formed on the appropriate positions on one type of optical recording medium, it is not possible to form light spots with the three beams on the appropriate positions over the other type of optical recording medium.

Moreover, since the diffraction angle of a diffraction grating is dependent on the wavelength, the light spot interval formed by the three returning laser beams reflected by the optical recording medium will differ with each laser beam.

Because of this, it would not be possible to receive the laser beams of respective wavelengths using a common photo detector device equipped with an ordinary push-pull type split-type photo detector surface. Therefore, it becomes necessary to arrange a photo detector device for each of the laser beams, or devise a way to increase the number of divided photo detector surfaces if a common photo detector device equipped with a split-type photo detector surface is used.

### SUMMARY OF THE INVENTION

In consideration of these problems, the present invention provides an optical pickup device that is capable of averting the occurrence of unnecessary diffracted light beams and prevents the decline in light usage efficiency when three beams are generated by diffracting laser beams with different wavelengths, using diffraction gratings arranged on a common light path.

Also, in accordance with one embodiment of the present invention, when three beams are generated by diffracting laser beams with different wavelengths, using diffraction gratings arranged on a common light path, an optical pickup device is capable of adjusting the direction of diffraction by each of the diffraction gratings so that the three beams of each of the laser beams can form light spots on the appropriate positions on corresponding optical recording media with different track pitches.

Moreover, in accordance with one embodiment of the present invention, an optical pickup device uses a common photo detector element to receive in a suitable state returning beams of three laser beams with different wavelengths formed by diffraction grating arranged on a common light path, which return from an optical recording medium.

In accordance with an embodiment of the present invention, an optical pickup device is equipped with a first light source that emits a first laser beam, a second light source that emits a second laser beam having a wavelength shorter than a wavelength of the first laser beam, and a common light path that conducts the first laser beam and the second laser beam emitted from the respective light sources to an optical recording medium. The optical pick up device includes a first diffraction grating and a second diffraction grating disposed on the common light path arranged in this order from the first and second light sources, wherein the first diffraction grating diffracts the first laser beam and generates three beams for detecting tracking error, and transmits the second laser beam without diffracting the second laser beam, and the second diffraction grating diffracts the second laser beam and generates three beams for detecting tracking error, and transmits the first laser beam without diffracting the first laser beam.

In the present invention, there is no unneeded diffracted beam generated because the laser beams of respective wavelengths are not subject to unnecessary diffraction.

Therefore, it is possible to restrain the decline in the light intensity of the three beams for detecting tracking errors. Also, as the first diffraction grating on the longer wavelength side with a larger diffraction angle is located on the light source side, it is possible to widen the grating pitch of the diffraction grating as compared to the case when the second diffraction grating on the shorter wavelength side with a smaller diffraction angle is located on the light source side. Thus, this fact facilitates the manufacturing of diffraction grating.

Moreover, as the laser beams of respective wavelengths are not subject to unnecessary diffraction, it is possible to appropriately position the beam spots of the three beams formed through diffraction on an optical recording medium by adjusting the rotation of the respective diffraction gratings around the light axis.

Also, it becomes easier to set the returning light of the three beams with respective wavelengths returning from an optical recording medium so that they can be received by the common photo detector device.

The first and second diffraction gratings may be retained in a state in which they can be rotated around the light axis in unison. This facilitates adjustment of positions at which the beam spots are formed on an optical recording medium and positions at which the beam spots are formed on the photo detector device.

Also, the first and second diffraction gratings can be made into a single diffraction grating equipped with a substrate, a first diffraction surface formed on one side of the substrate that functions as the first diffraction grating, and a second diffraction surface on the other side of the substrate that functions as the second diffraction grating.

Moreover, in order to form beam spots for the three beams on appropriate positions against the respective optical recording media with different track pitches, the direction of gratings formed on the diffraction surface of the first diffraction grating and the direction of gratings formed on the diffraction surface of the second diffraction grating may be arranged to form a specified angle.

Next, when there is a common photo detector device for receiving the returning light of laser beams with the respective wavelengths, the distance between the first diffraction grating and the first light source and the distance between the second diffraction grating and the second light source may be set so that the returning light of the laser beams of the respective wavelengths converge on the common photo detector device.

Other objects, features and advantages of the invention will become apparent from the following detailed description taken in conjunction with the accompanying drawings.

### BRIEF DESCRIPTION OF THE DRAWINGS:

FIG. 1 schematically shows a configuration of an optical system for an optical pickup device in accordance with an embodiment of the present invention.

FIGS. 2(a), (b) and (c) show a cross section, a left-side view and a right-side view of the diffraction grating shown in FIG. 1, respectively.

FIG. 3 is an illustration to describe a diffraction angle of laser beam diffracted by the diffraction grating of the optical pickup device shown in FIG. 1 and the angle of incidence of the returning light converging on the common photo detector device.

FIG. 4 is an illustration to describe spot positions of laser beam for reproducing data on different types of optical recording media.

FIG. 5 is an illustration to describe a common photo detector device that receives returning light from different types of optical recording media.

### DESCRIPTION OF PREFERRED EMBODIMENTS

An example of an optical pickup device in accordance with one embodiment of the present invention will be described with reference to the accompanying drawings.

(General Structure)

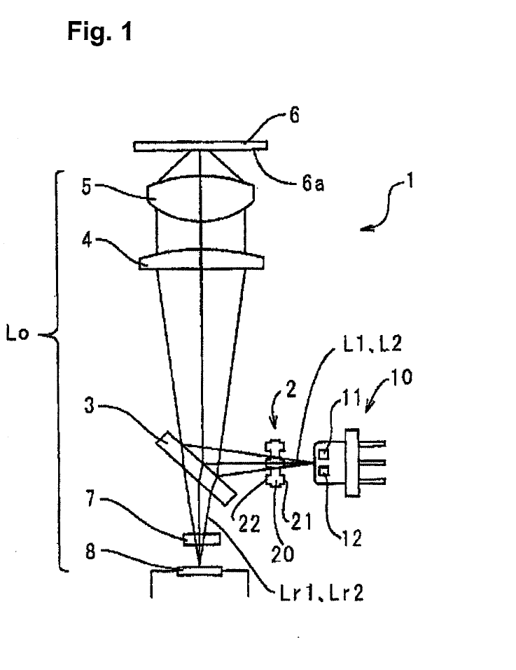

FIG. 1 schematically shows a structure of an optical system of the optical pickup device. The optical pickup device 1 is used to reproduce information recorded on multiple different types of optical recording media 6 such as a CD, CD-R and DVD with different substrate thickness and recording densities. The optical pickup device is equipped with a two-wavelength light source 10 that houses in a common package a first laser diode 11 that emits a first laser beam L1 with a wavelength of 780 nm and a second laser diode 12 that emits a second laser beam L2 with a wavelength of 650 nm, and a common optical system Lo.

The two-wavelength light source 10 may be a monolithic type in which light sources for emitting light of two wavelengths are formed on a single semiconductor substrate, or a hybrid type that combines individual chips for emitting light of two wavelengths.

The common optical system Lo includes a diffraction grating 2 that generates three light beams by diffracting each of the first laser beam L1 and the second laser beam L2 emitted from the two-wavelength light source 10, a flat plate type beam splitter 3 that separates the emitted laser beams L1 and L2 from returning light beams Lr1 and Lr2, a collimator lens 4 that forms parallel laser beams from the laser beam L1 and L2 conducted by the beam splitter 3 and an object lens 5 that converges the laser beams L1 and L2 projected from the collimator lens 4 to a recording surface 6a of an optical recording medium 6.

Also, arranged on the common optical system Lo are a light axis adjustment device 7 that corrects a deviation between the light axes of the returning light Lr1 and Lr2 of the first laser beam L1 and the second laser beam L2 that have passed the beam splitter 3 after being reflected on the recording surface 6a of the optical recording medium 6, and a common photo detector device 8 for receiving the returning light Lr1 and Lr2.

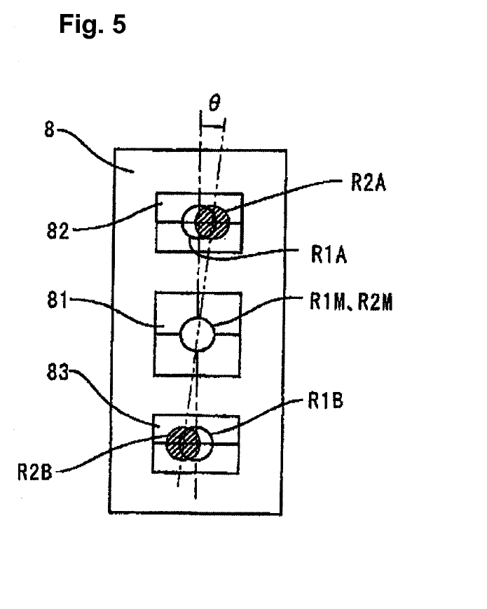

The common photo detector device 8 is a differential push-pull type equipped with a split-type photo detector surface consisting of a main photo detector section for the main beam against the three returning beams Lr1 and Lr2 and two sub photo detector sections for sub-beams (See FIG. 5).

In the optical pickup device 1 with the structure described above, the first laser beam light source 11 emits the first laser beam L1 with a wavelength of 780 nm when the optical recording medium 6 is a CD-R and data on the CD-R is reproduced. The first laser beam L1 is guided to the common optical system Lo via the diffraction grating 2, and is converged as a light spot on the recording surface of CD-R by the object lens 5. The returning light Lr1 of the first laser beam L1, reflected on the recording surface of the CD-R and passing through the beam splitter 3, converges on the common photo detector device 8, and the CD-R information is reproduced from signals detected by the common photo detector device 8.

In contrast, when the optical recording medium 6 is a DVD and information on the DVD is reproduced, the second laser beam L2 with a wavelength of650 nm is emitted from the second laser light source 12. The second laser beam L2 is also guided to the common optical system Lo through the diffraction grating 2, and is converged as a light spot on the recording surface of the DVD by the object lens 5. The returning light Lr2 of the second laser beam L2, reflected on the DVD recording surface and passing through the beam splitter 3, converges on the common photo detector device 8. The DVD information is reproduced from signals detected by the common photo detector device 8.

(Diffraction Grating)

The diffraction grating 2 generates three beams by diffracting the first laser beam L1 with a longer wavelength of 780 nm and the second laser beam L2 with a shorter wavelength of 650 nm emitted from the two-wavelength light source 10 to perform tracking error detection using a three-beam method (3-spot method).

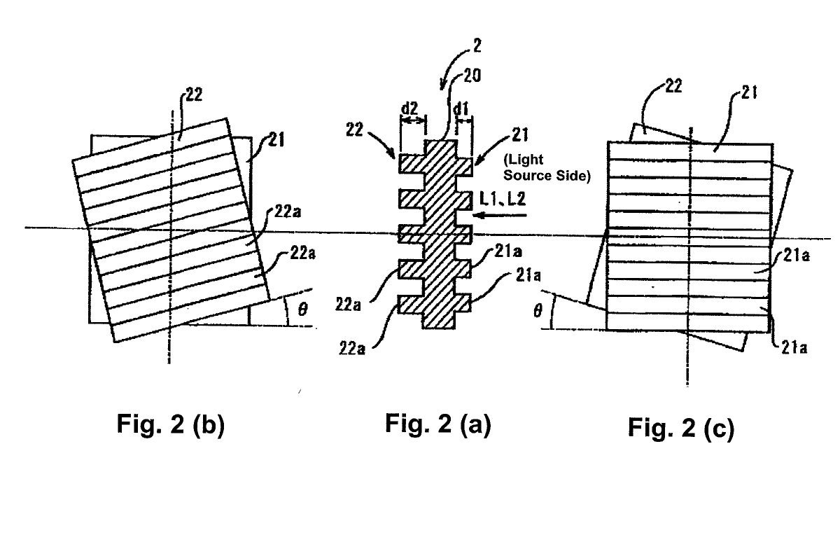

FIGS. 2(a), 2(b) and 2(c) show a cross-sectional view, a left side view and a right side view of the diffraction grating 2, respectively. As shown in these drawings, the diffraction grating 2 is equipped with a substrate 20 that is transparent to the wavelengths used, a first diffraction grating surface 21 that functions as a first diffraction grating formed on one surface of the substrate 20 and a second diffraction grating surface 22 that functions as a second diffraction grating formed on the other surface of the substrate 20.

The first diffraction grating surface 21 diffracts the 780 nm laser beam on the long wavelength side and transmits the 650 nm laser beam on the short wavelength side intact without diffracting the same. In other words, the650 nm laser beam makes a straight advancement through the first diffraction grating surface 21.

In contrast, the second diffraction grating surface 22 transmits the 780 nm laser beam on the long wavelength side intact without diffracting the same, and diffracts the650 nm laser beam on the short wavelength side. In other words, the 780 nm laser beam makes a straight advancement through the second diffraction grating surface 22.

The diffraction grating 2 with this structure is arranged on the common light path for the respective laser beams L1 and L2 in a state in which the first diffraction grating surface 21 faces the two-wavelength light source 10.

Also, the direction of periodic lattice 21a formed on the first diffraction grating surface 21 and the direction of periodic lattice 22a formed on the second diffraction grating surface 22 form a predetermined angle θ.

In a typical configuration of the first diffraction grating surface 21, a step difference d1 of the periodic lattice 21a is set to generate a light path difference of 2π, which is equivalent to one wavelength, when the second laser beam L2 with the short wavelength 650 nm passes the first diffraction grating surface 21. Therefore, the first diffraction grating surface 21 allows the second laser beam L2 to make a linear advance but diffracts the first laser beam L1. The step difference d1 can be given by the following equation when the wavelength of the second laser beam on the short wavelength side is λ2, and a refractive index of the substrate is n.

d1=λ2/(n−1)

Similarly, in a typical configuration of the second diffraction grating surface 22, a step difference d2 of the periodic lattice 22a is set to generate a light path difference of 2 π, which is equivalent to one wavelength, when the first laser beam L1 with the long wavelength 780 nm passes the second diffraction grating surface 22. Therefore, the second diffraction grating surface 22 allows the first laser beam L1 to make a linear advance but diffracts the second laser beam L2. The step difference d2 can be given by the following equation when the wavelength of the first laser beam on the long wavelength side is λ1, and the refractive index of the substrate is n.

d2=λ1/(n−1)

Here, an explanation will be given as to the reasons for arranging the first diffraction grating surface 21 on the long wavelength side on the side of the two-wavelength light source 10.

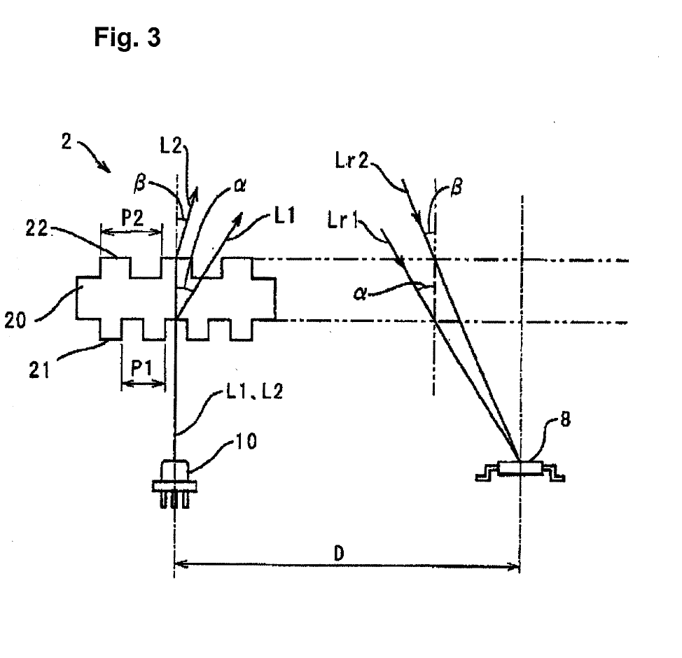

FIG. 3 shows the relationship between the diffraction angle of the laser beam diffracted by the first and second diffraction grating surfaces 21 and 22, and the angle of incidence of the returning beam that converges on the common photo detector device 8. Of the laser beams L1 and L2 emitted by the light source 10, the diffraction grating 2 diffracts the laser beam L1 on the long wavelength side at a diffraction angle of α, and diffracts the laser beam L2 on the short wavelength side at a diffraction angle of β.

The common photo detector device 8 is arranged in an optical position, which is spaced a distance D away from the two-wavelength light source 10. The returning beam Lr1 of the laser beam L1, reflected from an optical recording medium 6, is incident upon the photo detector surface of the common photo detector device 8 with a diffraction angle α as an incidence angle. Similarly, the returning beam Lr2 of the laser beam L2 is incident upon the photo detector surface with a diffraction angle β as an incidence angle.

These diffraction angles α and β are obtained as values satisfying the following equations, when the grating pitch of the first diffraction grating surface 21 is P1 and the grating pitch of the second diffraction grating surface 22 is P2.

Sin(α×D)=λ1×P1

Sin(α×D)=λ2×P2

If the grating pitch P1 and the grating pitch P2 are the same, the incidence angle of the returning beam Lr1 on the common photo detector device 8 becomes larger as the diffraction angle of the laser beam L1 having a longer wavelength increases.

Therefore, it is possible to make the grating pitch P1 and P2 wider by disposing the first diffraction grating surface 21 on the side of light source 10 compared to the case where the second diffraction grating surface 22 is disposed on the side of the two-wavelength light source 10,.

Next, glass or optical plastic is commonly used as the substrate 20 that comprises the diffraction grating 2. As the refractive index of these substrates is about 1.5, the step differences d1 and d2 can be given as follows.

d1=λ2/0.5=2×λ2

d2=λ1/0.5=2×λ1

As explained above, the step differences d1 and d2 are twice as much as the wavelengths λ2 and λ1, respectively. As the pitch grating can be widened, it becomes easier to form the step differences d1 and d2, thus, making it easy to manufacture the diffraction grating 2.

Next, as explained above, the direction of the periodic lattice 22a of the second diffraction grating surface 22 is inclined at an angle θ around the light axis against the direction of the periodic lattice 21a of the first diffraction grating 21. As a result, the diffraction direction of the laser beam L2 on the short wavelength side caused by the second diffraction grating surface 22 has an inclination angle θ against the diffraction direction of the laser beam L1 on the long wavelength side caused by the first diffraction grating surface 21.

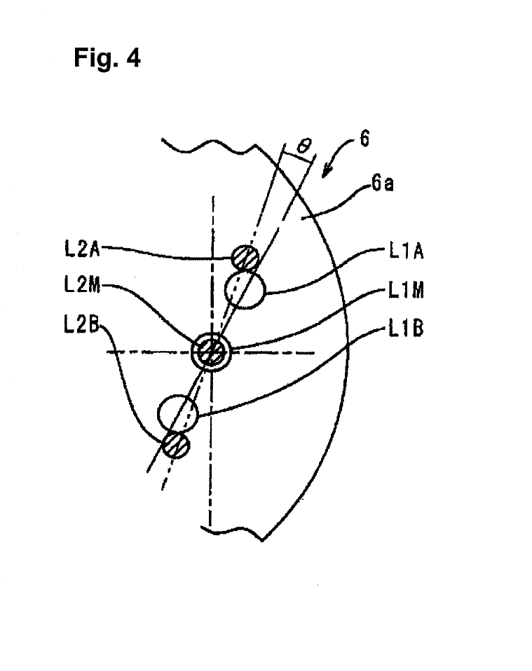

The angle θ is set according to the spot position of the beam under different types of optical recording media. FIG. 4 is shows spot positions of the laser beams for reproducing data for different types of optical recording media. FIG. 4 will be used to explain how the inclination angle θ is set.

Three beam spots of the long wavelength laser beam L1 on the recording surface 6a of the optical recording medium 6, for reproducing data on an optical recording medium 6, are located at a main spot L1M, and a first sub spot L1A and a second sub spot L1B on the upper right and lower left of the main spot L1M. Three beam spots of the short wavelength laser beam L2 on the recording surface 6a of the optical recording medium 6 are located at a main spot L2M, and a first sub spot L2A and a second sub spot L2B on the upper right and lower left of the main spot L2M.

If the centers of the respective main spots L1M and L2M of the long wavelength laser beam L1 and short wavelength laser beam L2 are aligned with each other, the sub spots L1A and L1B of the first laser beam L1 will be positioned at an angle θ around the light axis against the sub spots L2A and L2B of the second laser beam L2 due to the difference in track pitch. As the direction of the periodic lattice 21a of the first diffraction grating surface 21and the direction of the periodic lattice 22a of the second diffraction grating surface 22 on the diffraction grating 2 are inclined with respect to each other at an angle θ around the light axis in alignment with the angle θ, the respective laser beams L1 and L2 passing through the diffraction grating 2 will respectively form light spots on the appropriate positions on the optical recording medium 6.

As a result, the adjustment of both of the diffraction grating surfaces 21 and 22 can be performed merely by adjusting the rotation of the first and second diffraction grating surfaces 21 and 22 of the diffraction grating 2.

Similarly, the spot forming positions of the three beams formed on the photo detector surface of the common photo detector device 8 can be adjusted.

FIG. 5 is an illustration of the common photo detector device 8 which receives light returning from different types of optical recording media. As indicated in this figure, the common photo detector device 8, which is a differential push-pull type, is equipped with a four-segment type main photo detector device 81 to receive the main beam among the three returning beams and two two-segment type sub photo detector devices 82 and 83 to receive the two sub beams. First and second main returning spots R1M and R2M of the first return light Lr1 and second return light Lr2 converge on the main photo detector device 81, while first sub returning spots R1A and R1B and second sub return spots R2A and R2B converge on the sub beam detector devices 82 and 83, respectively.

When the centers of the main returning spots R1M and R2M of the laser beams are aligned, the first and second returning lights Lr1 and Lr2 are received by the common photo detector device 8 such that the sub returning spots R2A and R2B of the second laser beam are received by the common photo detector device 8 at positions inclined at an angle θ about the light axis with respect to the sub returning spots R1A and R1B of the first laser beam Lr1 due to the difference in track pitch of the optical recording media 6. This angle θ is the same as the angle defined between the grating directions of the first diffraction grating surface 21 and the second diffraction grating surface 22 of the diffraction grating 2. Accordingly, with the diffraction grating 2, it is possible to converge the return lights Lr1 and Lr2 on the common photo detector device 8.

Thus, in the optical pickup device 1, the usage efficiency of the respective laser beams can be enhanced by using the diffraction grating 2 that has the first and second diffraction grating surfaces because unnecessary diffraction against the first laser beam L1 on the long wavelength side and the second laser beam L2 on the short wavelength side emitted from the two-wavelength light source 10 can be averted.

Also, because the diffraction grating 2 has the first diffraction grating surface 21 disposed on the side of the two-wavelength light source 10, it facilitates to manufacture a diffraction grating because the grating pitch can be made wider compared to the case when the second diffraction grating surface 22 is placed on the side of the two-wavelength light source 10.

Moreover, the adjustment of the rotation of the diffraction grating 2 can be simplified, and the common photo detector device 8 can be used because the diffraction grating 2 has a structure in which the second diffraction grating surface 22 is inclined at a specified angle with respect to the first diffraction grating surface 21 in line with the track pitches of different types of optical recording media 6 whose recorded information are reproduced by the optical pickup apparatus 1.

Moreover, in the embodiment example described, the diffraction grating 2 has a structure in which its first and second diffraction grating surfaces 21 and 22 are formed on both sides of a single substrate 20. However, it can be separated into two diffraction elements with the first element equipped only with the first diffraction grating surface 21 and the second element equipped only with the second diffraction grating surface 22. In this case, it is recommended that both of the diffraction elements may be designed to rotate about the light axis as one in order to facilitate adjustment by using a common holder to support the two diffraction elements.

On the other hand, while the above embodiment example has two laser light sources, the present invention is also applicable to optical pickup devices with three or more laser light sources.

As explained above, an optical pickup device in accordance with the present invention has first and second diffraction gratings arranged in this order from a light source side on a common optical path through which laser beams of different wavelengths pass, and the grating surfaces of the first and second diffraction gratings are designed such that the first diffraction grating diffracts only a laser beam on the long wavelength side and the second diffraction grating diffracts only a laser beam on the short wavelength side.

Therefore, the present invention can prevent laser beams of respective wavelengths emitted from the light sources from repeatedly being diffracted by the respective diffraction gratings arranged on the common light path, and thus prevents decline in the usage efficiency of light caused by the generation of unnecessary diffracted light.

Moreover, as the first diffraction grating that diffracts a laser beam on the long wavelength side is placed on the side of the laser light source, it is possible to widen the pitch of the diffraction gratings. Therefore, the manufacturing of diffraction gratings is facilitated.

Moreover, the directions of the periodic lattices of the first and second diffraction gratings are shifted from one another at a specified angle that matches the tracking pitches of different types of optical recording media whose information are reproduced by the optical pickup device.

Therefore, the diffraction gratings can be readily adjusted about the light axis so that light spots of the three beams are formed on the appropriate positions on the respective optical recording media.

In addition, by appropriately setting the distances between the respective diffraction gratings and the respective light sources so that returning lights of the laser beams of respective wavelengths converge on the common photo detector device, it is possible to form light spots from the returning lights of the three beams of respective wavelengths on the appropriate positions on the common photo detector device.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical pickup device comprising:
a first light source that emits a first laser beam;
a second light source that emits a second laser beam having a wavelength shorter than a wavelength of the first laser beam;
a common light path that conducts the first laser beam and the second laser beam emitted from the first and second light sources to a predetermined surface; and
a first diffraction grating and a second diffraction grating disposed on the common light path arranged in this order from the first and second light sources, wherein the first diffraction grating diffracts the first laser beam and transmits the second laser beam without diffracting the second laser beam, and the second diffraction grating diffracts the second laser beam and transmits the first laser beam without diffracting the first laser beam.

2. An optical pickup device according to claim 1, wherein the first diffraction grating generates three beams for detecting tracking error, and the second diffraction grating generates three beams for detecting tracking error.

3. An optical pickup device according to claim 1, wherein the first and second diffraction gratings are retained in a state in which the first and second diffraction gratings can be rotated around the light axis in unison.

4. An optical pickup device according to claim 3, wherein the first and second diffraction gratings are formed from a single diffraction grating equipped with a substrate, a first diffraction surface formed on one side of the substrate that functions as the first diffraction grating, and a second diffraction surface on the other side of the substrate that functions as the second diffraction grating.

5. An optical pickup device according to claim 3, wherein the first and second diffraction gratings are formed on two independent diffraction elements, respectively, the two independent diffraction elements being retained by a common holder member.

6. An optical pickup device according to claim 3, wherein the direction of gratings formed on a diffraction surface of the first diffraction grating and the direction of gratings formed on a diffraction surface of the second diffraction grating define a specified angle.

7. An optical pickup device according to claim 3, wherein the first diffraction grating has a periodic lattice with a step difference d1 that is defined by d1=λ2/(n−1) where λ2 is a wavelength of the second laser beam on a short wavelength side, and n is a refractive index of the substrate, and the second diffraction grating has a periodic lattice with a step difference d2 that is defined by d2=λ1/(n−1) where λ1 is a wavelength of the first laser beam on a long wavelength side.

8. An optical pickup device according to claim 1, further comprising a common photo detector device that receives returning lights of the first and second laser beams reflected on the predetermined surface, wherein the distance between the first diffraction grating and the first light source and the distance between the second diffraction grating and the second light source are set such that returning lights of the first and second laser beams converge on the common photo detector device.

9. An optical pickup device comprising:
a light source that emits a first laser beam and a second laser beam, the second laser beam having a wavelength shorter than a wavelength of the first laser beam;
a common light path that conducts the first laser beam and the second laser beam emitted from the first and second light sources to a predetermined surface; and
a diffraction grating having a substrate, a first diffraction surface formed on one side of the substrate and a second diffraction surface formed on the other side of the substrate, wherein the first diffraction surface diffracts only the first laser beam, and the second diffraction surface diffracts only the second laser beam.

10. An optical pickup device according to claim 9, wherein the first diffraction surface allows the second laser beam to linearly advance therein without diffracting the second laser beam, and the second diffraction surface allows the first laser beam to linearly advance therein without diffracting the second laser beam.

11. An optical pickup device according to claim 9, wherein the first diffraction surface is located closer than the second diffraction surface to the light source.

12. An optical pickup device according to claim 9, wherein the first diffraction surface has a first grating extending in a first direction and the second diffraction surface has a second grating extending in a second direction, wherein the first diffraction surface is rotated about a light axis of the common light path with respect to the second diffraction surface such that the first direction and the second direction defines an angle.

13. An optical pickup device according to claim 9, wherein the first diffraction surface has a periodic lattice with a step difference d1 that is defined by d1=λ2/(n−1) where λ2 is a wavelength of the second laser beam on a short wavelength side, and n is a refractive index of the substrate, and the second diffraction surface has a periodic lattice with a step difference d2 that is defined by d2=λ1/(n−1) where λ1 is a wavelength of the first laser beam on a long wavelength side.

14. An optical pickup device according to claim 9, wherein the first and second diffraction surfaces are rotatable in unison around a light axis.

15. An optical pickup device according to claim 9, wherein the first diffraction surface diffracts the first laser beam and generates three beams, and the second diffraction surface diffracts the second laser beam and generates three beams.

16. An optical pickup device according to claim 9, wherein the diffraction grating is composed of two independent diffraction elements, the first diffraction surface formed on one of the diffraction elements and the second diffraction surface formed on the other of the diffraction elements, and the two independent diffraction elements are retained by a common holder member.

17. A diffraction grating for an optical pickup device, the optical pickup device having a light source that emits a first laser beam and a second laser beam, the second laser beam having a wavelength shorter than a wavelength of the first laser beam, the diffraction grating comprising:
a substrate, a first diffraction surface formed on one side of the substrate and a second diffraction surface formed on the other side of the substrate, wherein the first diffraction surface diffracts only the first laser beam, and the second diffraction surface diffracts only the second laser beam.

18. A diffraction grating according to claim 17, wherein the first diffraction surface allows the second laser beam to linearly advance therein without diffracting the second laser beam, and the second diffraction surface allows the first laser beam to linearly advance therein without diffracting the second laser beam.

19. A diffraction grating according to claim 17, wherein the first diffraction surface is located closer than the second diffraction surface to the light source.

20. A diffraction grating according to claim 17, wherein the first diffraction surface has a first grating extending in a first direction and the second diffraction surface has a second grating extending in a second direction, wherein the first diffraction surface is rotated about a light axis with respect to the second diffraction surface such that the first direction and the second direction defines an angle.

21. A diffraction grating according to claim 17, wherein the first diffraction surface has a periodic lattice with a step difference d1 that is defined by d1 =λ2/(n−1) where λ2 is a wavelength of the second laser beam on a short wavelength side, and n is a refractive index of the substrate, and the second diffraction surface has a periodic lattice with a step difference d2 that is defined by d2 =λ1/(n−1) where λ1 is a wavelength of the first laser beam on a long wavelength side.
